(19) United States
(12) Patent Application Publication
(10) Pub. No.: US 2005/0255752 A1
(43) Pub. Date: Nov. 17, 2005

(54) Electrical connector

(75) Inventor: Hung-Way Huang, Taipei Hsien (TW)

Correspondence Address: BRUCE H. TROXELL;SUITE 1404, 5205 LEESBURG PIKE, FALLS CHURCH, VA, 22041, US

(73) Assignee: Advanced Connectek Inc.

(21) Appl. No.: 11/011,125

(22) Filed: Dec. 15, 2004

(30) Foreign Application Priority Data
May 13, 2004 (TW) 093207453

(51) Int. Cl. H01R 13/627

(52) U.S. Cl. 439/607

(57) ABSTRACT

Provided is a HDMI type electrical connector assembly comprising an insulative body comprising a rear parallelepiped member including at least one top recess having at least one top tab, and at least one bottom tab; parallel conductors; a grounding member; a rear member including two side protrusions; a metal front housing formed by bending a metal sheet and comprising a front projected sheath including upper and lower flanges extended rearwards for fastening the insulative body and the rear member; upper and lower holding members together for pressing the rear member therebetween; and a plastic case comprising top and bottom shells each having a U-shaped section and comprising latches and holes disposed on both sidewalls such that the bottom and the top shells can be matingly coupled together.

### BACKGROUND OF THE INVENTION

1. Field of the Invention

The present invention relates to electrical connectors and more particularly to a HDMI type electrical connector assembly with improved characteristics.

2. Description of Related Art

Electrical connectors are employed in the ends of cables for electrically coupling two electronic devices together for signal communication therebetween. Also, a wide variety of advanced electronic products such as LCDs (liquid crystal displays) are commercially available as time evolves. Thus, continuing improvements in the exploitation of electrical connector are constantly being sought by the manufacturers for meeting existing electrical requirements. For instance, HDMI (high definition multimedia interface) type electrical connectors are newly developed. HDMI type connectors have the advantages of DVI (digital video interface) type connectors while without its disadvantages. Also, HDMI type connectors are much compact for being easily adapted to mount in an AV (audio video) product.

However, metal shrouds of the well known HDMI type connectors suffered from several disadvantages including low precision, being difficult of being machined, and low yield due to the undesired extrusion process. Thus, it is desirable to provide an improved HDMI type electrical connector.

### SUMMARY OF THE INVENTION

It is an object of the present invention to provide an electrical connector assembly being formed by a simple bending process so as to facilitate assembly.

It is another object of the present invention to provide an electrical connector assembly having all components enclosed so as to substantially eliminate EMI during operating.

It is a further object of the present invention to provide an electrical connector assembly having a plurality of fastening arrangements in a metal front housing and a plastic case such that fastening of the internal components is more reliable.

To achieve the above and other objects, the present invention provides an electrical connector assembly comprising an insulative body comprising a rear parallelepiped member including at least one top recess having at least one tab, and at least one bottom tab; a plurality of parallel conductors; a grounding member; a rear member including two side protrusions; a metal front housing formed by bending a metal sheet and comprising a front projected sheath including upper and lower flanges extended rearwards for fastening the insulative body and the rear member; upper holding member and lower holding member together adapted to press the rear member therebetween; and a plastic case comprising a top shell and a bottom shell each having a U-shaped section and comprising a plurality of latches and holes disposed on both sidewalls such that the latches of the top shell are adapted to insert into the holes of the bottom shell and the latches of the bottom shell are adapted to insert into the holes of the top shell for fastening both the bottom and the top shells together.

The above and other objects, features and advantages of the present invention will become apparent from the following detailed description taken with the accompanying drawings.

### BRIEF DESCRIPTION OF THE DRAWINGS

FIG. 1 is an explode perspective view of a preferred embodiment of electrical connector assembly according to the invention;

FIG. 2 is another explode perspective view of the electrical connector assembly shown in FIG. 1 viewed oppositely; and

FIG. 3 is a perspective view of the assembled electrical connector assembly.

### DETAILED DESCRIPTION OF THE PREFERRED EMBODIMENTS

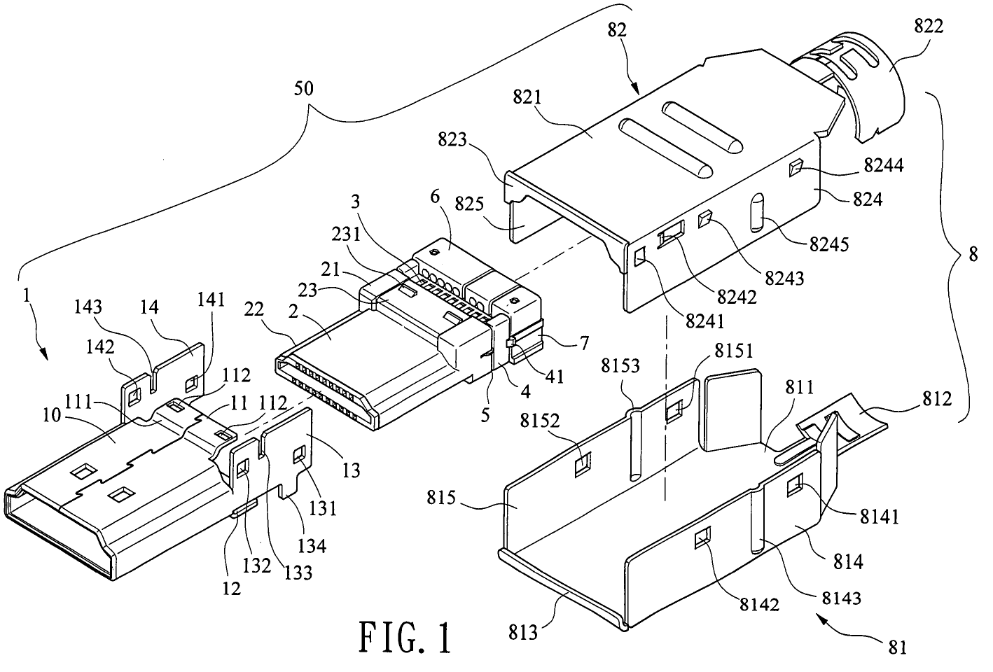

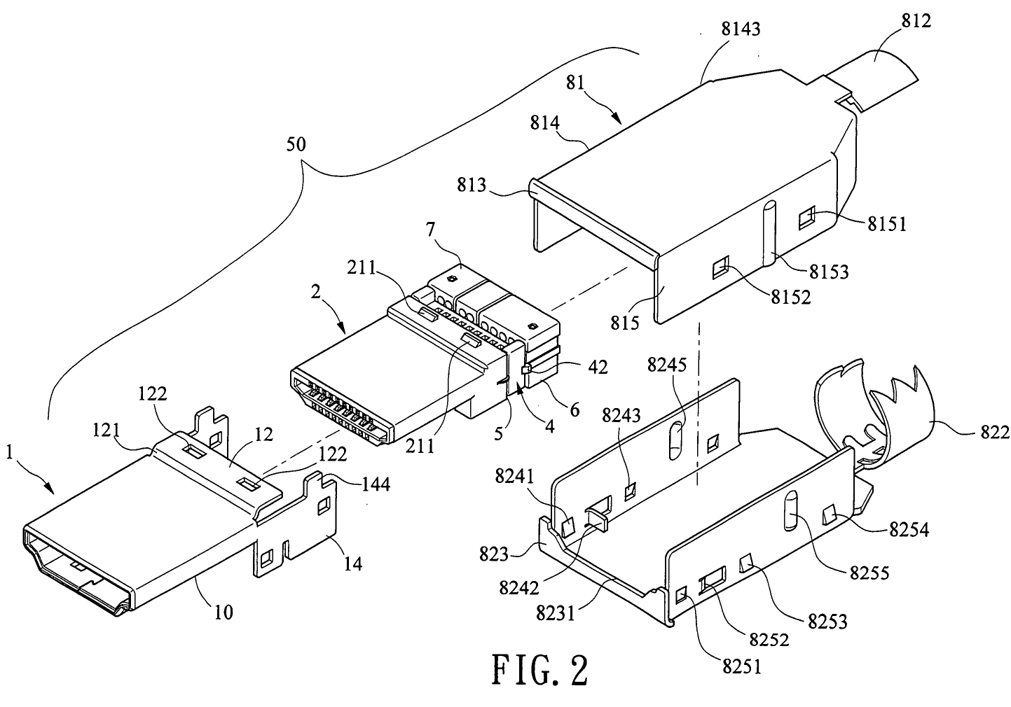

Referring to FIGS. 1 to 3, there is shown a HDMI type electrical connector assembly 50 constructed in accordance with a preferred embodiment of the invention.

The parallelepiped connector assembly 50 comprises a metal front housing 1, an insulative body 2, a plurality of parallel conductors 3, a rear member 4, a grounding member 5, upper holding member 6 and lower holding member 7, and a plastic case 8. Each component will be described in detailed below.

The front housing 1 is formed by bending a metal sheet and comprises a front projected sheath 10 having a HDMI type opening at either end, upper and lower flanges 11, 12 each having a bent member 111 or 121 formed with the sheath 10, a pair of openings 112 formed on the upper flange 11, a pair of openings 122 formed on the lower flange 12, right and left positioning members 13, 14 protruded rearwards from a rear end, a pair of openings 131, 132 formed on the right positioning member 13, a pair of openings 141, 142 formed on the left positioning member 14, an upper dent 133 formed on the right positioning member 13, an upper dent 143 formed on the left positioning member 14, a lower leg 134 formed on the right positioning member 13, and a lower leg 144 formed on the left positioning member 14.

The insulative body 2 comprises a rear parallelepiped member 21 and a forward extension 22. A recess 23 is provided on a top of the parallelepiped member 21. The recess has a width conformed to that of the upper flange 11. Two tabs 231 are provided on the recess 23 and are adapted to insert in the openings 112 for fastening. Also, two tabs 211 are provided on a bottom of the parallelepiped member 21 and are adapted to insert in the openings 122 for fastening.

The parallelepiped rear member 4 is formed at a rear of the body 2 and comprises protrusions 41, 42 at both sides. The protrusions 41 are adapted to insert into the openings 131, 141 for fastening. Further details of the rear member 4, the conductors 3, the grounding member 5 coupled between the body 2 and the rear member 4, and the upper holding member 6 and the lower holding member 7 for pressing the rear member 4 therebetween will not be described in detail since they are well known. A first stage of assembly of the connector assembly 50 is finished after assembling the front housing 1 with the body 2, the conductors 3, the rear member 4, the grounding member 5, the upper holding member 6, and the lower holding member 7.

The parallelepiped case 8 comprises a top shell 82 and a bottom shell 81 each formed by bending a metal sheet. The bottom shell 81 comprises a rectangular flat 811, a curved rear extension 812 formed with the flat 811, an elongate lip 813 at a forward end, the lip 813 adapted to snap onto the bent member 121, two sidewalls 814, 815, two openings 8141, 8142 formed on one sidewall 814, two openings 8151, 8152 formed on the other sidewall 815, an upright trough 8143 having a curved section provided between the openings 8141 and 8142, and an upright trough 8153 having a curved section provided between the openings 8151 and 8152.

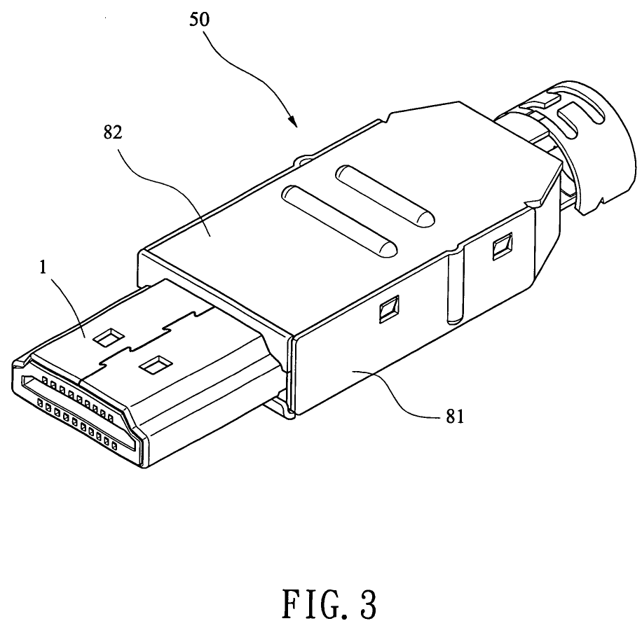

The top shell 82 comprises a rectangular flat 821, a curved rear extension 822 formed with the flat 821, the extensions 812 and 822 together adapted to clamp a passed cable, an elongate lip 823 at a forward end, the lip 823 having a groove 8231 in its intermediate portion to be matingly engaged with an outer surface of the sheath 10, the lip 823 adapted to snap onto the bent member 111, the lips 813 and 823 together adapted to prevent a removal of the components provided in the case 8, two sidewalls 824, 825, two protuberances 8241, 8251 provided on both sidewalls 824, 825 adjacent the lips 823, the protuberances 8241, 8251 adapted to insert into the openings 132,142 for fastening, latches 8242, 8252 provided on both sidewalls 824, 825 adjacent the protuberances 8241, 8251 respectively, the latches 8242, 8252 adapted to insert into the dents 133, 143 for fastening, a pair of tabs 8243, 8244 provided on the sidewall 824, the tabs 8243, 8244 being at the same elevation as the protuberance 8241 and the latch 8242, the tabs 8243, 8244 adapted to insert into the openings 8141, 8142 for fastening respectively, a pair of tabs 8253, 8254 provided on the sidewall 825, the tabs 8253, 8254 being at the same elevation as the protuberance 8251 and the latch 8252, the tabs 8253, 8254 adapted to insert into the openings 8151, 8152 for fastening respectively, an upright projection 8245 having a curved section provided between the tabs 8243 and 8244, the projection 8245 adapted to slide into the trough 8143 for positioning, and an upright projection 8255 having a curved section provided between the tabs 8253 and 8254, the projection 8255 adapted to slide into the trough 8153 for positioning. As a result, the top shell 82 and the bottom shell 81 are fastened together. This finishes the assembly of the connector assembly 50 as shown in FIG. 3.

Note that suitable gaps should be provided on the sides of the body 2 after assembling the body 2 and the rear member 4 such that the latches 8242, 8252 are adapted to insert thereinto later.

The benefits of the invention include: As compared with the prior extrusion process, the bending process of the invention is much simple and an assembly thereof is much easy. Also, many fastening arrangements are provided in the front housing 1 and the case 8 such that the fastening of the internal components is more reliable. Moreover, both signal transmission quality and speed are increased.

While the invention herein disclosed has been described by means of specific embodiments, numerous modifications and variations could be made thereto by those skilled in the art without departing from the scope and spirit of the invention set forth in the claims.

1. An electrical connector assembly comprising:
an insulative body comprising a parallelepiped rear member including at least one top recess having at least one top tab, and at least one bottom tab;
a plurality of parallel conductors;
a grounding member;
a rear member including two side protrusions;
a metal front housing formed by bending a metal sheet and comprising a front projected sheath including upper and lower flanges extended rearwards for fastening the insulative body and the rear member;
an upper holding member and a lower holding member together adapted to press the rear member therebetween; and
a case comprising a top shell and a bottom shell each having a U-shaped section and comprising a plurality of latches and holes disposed on both sidewalls thereof such that the latches of the top shell are adapted to insert into the holes of the bottom shell and the latches of the bottom shell are adapted to insert into the holes of the top shell for fastening both the bottom and the top shells together.

2. The electrical connector of claim 1, wherein each of the upper and lower flanges comprises at least one opening, each opening adapted to receive one of the inserted tab of the insulative body for fastening, and the sheath comprises two side first openings adapted to receive the inserted two protrusions of the rear member for fastening respectively, and two side positioning members protruded rearwards, each of the positioning members including two second openings, an upper dent, and a lower leg.

3. The electrical connector of claim 2, wherein each of the upper and lower flanges further comprises a bent member formed with the sheath, wherein the upper flange has a width substantially the same as that of the recess of the insulative body, and wherein the lower flange has a width substantially the same as that of the sheath.

4. The electrical connector of claim 1, wherein the bottom shell comprises a curved rear extension, an elongate lip disposed at a forward end, two openings formed disposed on either sidewall, and two troughs having a curved section each disposed between the openings of the bottom shell.

5. The electrical connector of claim 1, wherein the top shell comprises a curved rear extension together with the rear extension of the bottom shell for clamping a passed cable, an elongate lip disposed at a forward end, two side protuberances disposed adjacent the lips, the protuberances adapted to insert into the second openings for fastening, two side latches disposed adjacent the protuberances, the latches adapted to insert into the dents of the positioning member for fastening, two side tabs having the same elevation as the protuberance and the latch and being adapted to insert into the openings of the bottom shell for fastening, and two side projections having a curved section each disposed between the tabs of the top shell, the projections adapted to slide into the troughs of the bottom shell for positioning.

6. The electrical connector of claim 5, wherein the lip of the top shell comprises an intermediate groove matingly engaged with an outer surface of the sheath.
